(19) United States
(12) Patent Application Publication
(10) Pub. No.: US 2007/0110542 A1
(43) Pub. Date: May 17, 2007

(54) Screw locking arrangement

(75) Inventors: Claus Weimann, Wetter (DE); Norbert Schmidt, Lorch (DE)

Correspondence Address: CROWELL & MORING LLP;INTELLECTUAL PROPERTY GROUP, P.O. BOX 14300, WASHINGTON, DC, 20044-4300, US

(73) Assignee: ThyssenKrupp Bilstein Suspension GmbH, Ennepetal (DE)

(21) Appl. No.: 11/543,189

(22) Filed: Oct. 5, 2006

(30) Foreign Application Priority Data
Nov. 15, 2005 (DE) 10 2005 054 471.1

(51) Int. Cl. F16B 39/282

(52) U.S. Cl. 411/145

(57) ABSTRACT

Screw locking arrangement for a screw connection comprising a threaded spigot, a nut, a first locking washer and at least one second locking washer, wherein the first locking washer is connected in a non-rotational manner to the nut, wherein the first locking washer has first profiling on a first surface and the second locking washer has second profiling on a second surface, and wherein the profiling of the first locking washer is engaged with that of the second locking washer in such a way that a relative rotation of the two locking washers with respect to each other can be effected in only one rotational direction which leads to an increase in the tensioning force of the screw connection, wherein between the second locking washer and the threaded spigot a positive rotational locking arrangement is provided.

The invention relates to a screw locking arrangement for a screw connection comprising a threaded spigot, a nut, a first locking washer and at least one second locking washer, wherein the first locking washer is connected in a non-rotational manner to the nut, wherein the first locking washer has first profiling on a first surface and the second locking washer has second profiling on a second surface, and wherein the profiling of the first locking washer is engaged with that of the second locking washer in such a way that relative rotation of the two locking washers with respect to each other can be effected in only one rotational direction which leads to an increase in the tensioning force of the screw connection.

From DE-U 83 02 613 a screw and nut locking arrangement is known, consisting of a first locking ring, which on one of its sides has a roughened frictional surface or embossed radial ribs and on its other side has a plurality of wedge surfaces which rise in a flat manner in the peripheral direction and have end surfaces therebetween, and consisting of a part to be locked in the form of a similar second locking ring of a screw head or of a nut, which on its side facing the first locking ring is provided with similar wedge surfaces which rise oppositely to the wedge surfaces of the first locking ring and are supported thereon.

Similarly formed screw and nut locking arrangements are to be found in U.S. Pat. No. 3,263,727 and U.S. Pat. No. 4,134,438.

By reason of the pitch of the wedges, which is greater than the thread pitch of the spigot, a self-limiting arrangement for the connection is achieved. However, this known device has the constraint that it cannot be used on non-fixed plain washers since the whole system can rotate radially with the locking rings in the plane of separation of the plain washer, in particular in this case friction alone acts in association with the clamping force.

It is the object of the invention to develop the locking system described in the prior art in such a way that it can also be used on non-fixed plain washers. In this case it must be ensured that the screw connection is not loosened and the necessary pretensioning force of the screw connection is retained over the service life of the component used in each case.

This object is achieved in that a positive rotational locking arrangement is provided between the second locking washer and the threaded spigot.

Advantageous developments of the subject of the invention are to be found in the subordinate claims.

The screw connection in accordance with the invention can generally be applied to all screw connections which contain one or more parts which have a degree of freedom of movement in the rotational direction about the screw or spigot axis.

The axial pretensioning of the screw locking arrangement is not hindered as a result of the positive rotational locking arrangement but prevents a transfer of radial loosening moments from the unsecured washers to the nut.

Thus for example plates or the like which are to be connected to each other can easily be connected to each other by means of a screw provided with a spigot in cooperation with the screw locking arrangement in accordance with the invention, without the screw connection being loosened. In so doing the required pretensioning force of the screw connection is always available.

In particular, the subject of the invention can also be used to fasten and pretension for example a piston, containing a valve assembly, and plain washers on a piston rod spigot of a shock absorber. In this case there is an alternative possibility of using, instead of a nut, a housing with additional functionality, e.g. an amplitude-selective damping device, and a screw attachment operatively connected thereto. By means of the positive connection between the relevant washer and the spigot or rather, in the case of a shock absorber, the piston rod spigot, the components are prevented from rotating with respect to each other. Plain washers, which may lie thereunder if necessary, may rotate during operation since they no longer exert any loosening moment on the nut.

Depending on the design of the screw locking arrangement it may be advantageous for the first locking washer to be formed as a component separate from the nut. A non-rotational positive connection must then be provided between the nut and the first locking washer since otherwise the nut may be loosened by excitation of vibration, in particular high-frequency excitation of vibration.

It is also feasible for the positive connection to be produced by a rotational locking profile formed on the surface of the first locking washer facing the nut, which profile engages into a corresponding profile on the surface of the nut facing the locking washer.

It is also feasible for the positive connection to be produced by a rotational locking profile (e.g. radial ribs) formed on the surface of the first locking washer facing the nut, which profile is pressed into the surface of the nut when the screw connection is tightened, so that the positive rotational locking arrangement is produced.

For reasons of cost the person skilled in the art will pursue the design in which the rotational locking profile is provided on the first locking washer since in this case the lowest processing cost is involved.

In order to achieve the pretensioning force which must act upon the plain washer(s) the positive connection may, in the case of one selected embodiment, prevent only the relative movement in the rotational direction about the spigot axis between the lower washer of the locking system and the spigot and must permit a displacement which is axial with respect to the spigot axis and which permits the washer to be pressed against the plain washer(s).

In order to produce the positive connection at least one of the washers is provided with at least one radially inwardly directed lug-like radial projection which is engaged with a longitudinal groove, for example in the piston rod spigot. Alternatively, a plurality of lugs and longitudinal grooves can also be provided.

In accordance with a first specific embodiment two locking washers are provided in the screw locking arrangement in accordance with the invention and the positive rotational locking arrangement is formed by at least one radial projection which is formed on the second locking washer and which engages in a longitudinal groove formed in the threaded spigot, wherein a plain washer disposed adjacent to the second locking washer is provided to support further plain washers.

A second embodiment of the screw locking arrangement in accordance with the invention differs from the first embodiment in that the second locking washer (instead of the plain washer disposed adjacent thereto in the first exemplified embodiment) adopts the function of supporting the further plain washers. For this purpose the second locking washer is formed in such a way that it fulfills the function of supporting further plain washers, i.e. it has a sufficient, radially extending contact surface for the further plain washers. In contrast to the first exemplified embodiment in this exemplified embodiment the plain washer disposed adjacent to the second locking washer is omitted and axial construction height is therefore saved.

In accordance with a third embodiment of the screw locking arrangement in accordance with the invention two locking washers and a plain washer are provided, wherein the plain washer has at least one radial projection which, in order to form the positive rotational locking arrangement, engages into a longitudinal groove formed in the threaded spigot, wherein between the second locking washer and the plain washer a rotational locking arrangement, in particular a positive rotational locking arrangement, is provided. This exemplified embodiment has the advantage that the second locking washer has no radial projection so that for both locking washers it is possible to use locking washers which are commercially available at a favourable price and which are already provided with the necessary rotational locking profiles in the form of radial ribs. Only the plain washer must be provided with the radial projection which undergoes positive rotational locking with the threaded spigot.

If the positive rotational locking arrangement is provided between the second locking washer and the threaded spigot it is no longer necessary to have profiling for rotational locking on the surface facing the second locking washer of the adjoining plain washer, wherein this washer can at the same time be used to adjust the valve characteristics. Depending on the application, non-profiled end surfaces can be provided with a washer contour (planar, concave or the like), wherein the contours are embossed or ground.

The subject of the invention is described as follows and illustrated with the aid of an exemplified embodiment shown in the drawing in which:

FIG. 1 is a partial view of a piston rod end of a shock absorber operatively connected to a valve, together with a detailed view of the screw connection;

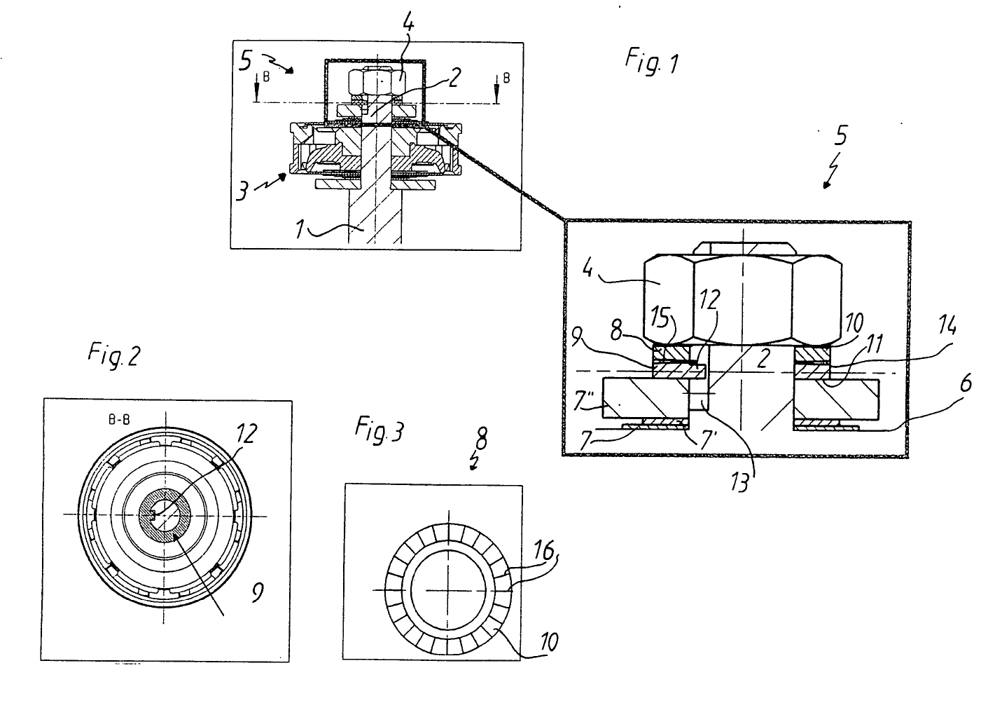

FIG. 2 is a cross-sectional view through FIG. 1 at the line B-B;

FIG. 3 is a partial view of a washer-like locking element;

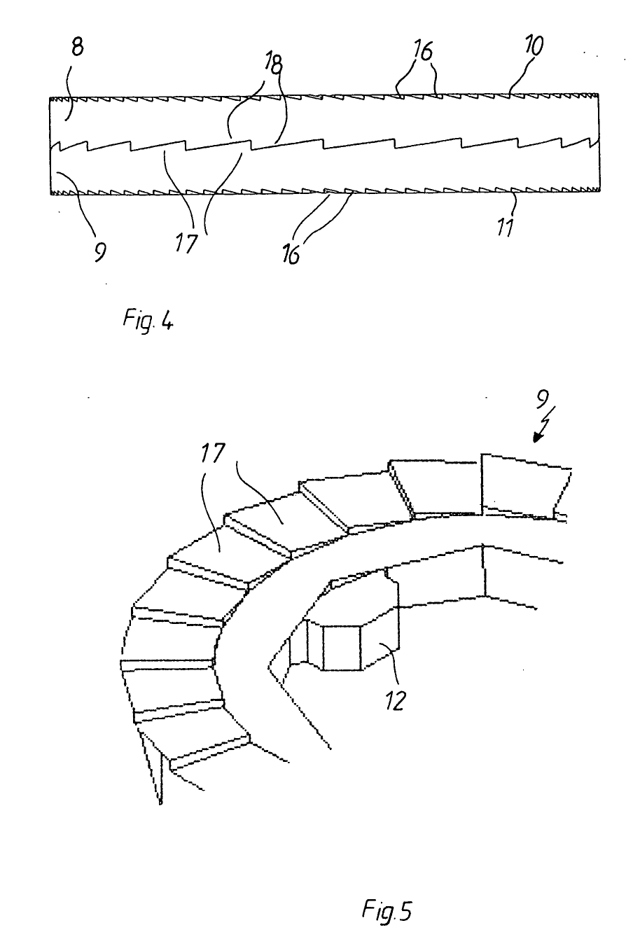

FIG. 4 is a schematic diagram of the locking system in accordance with FIG. 1;

FIG. 5 is a partial view of the profiling of one of the washers of the locking system in accordance with FIG. 4;

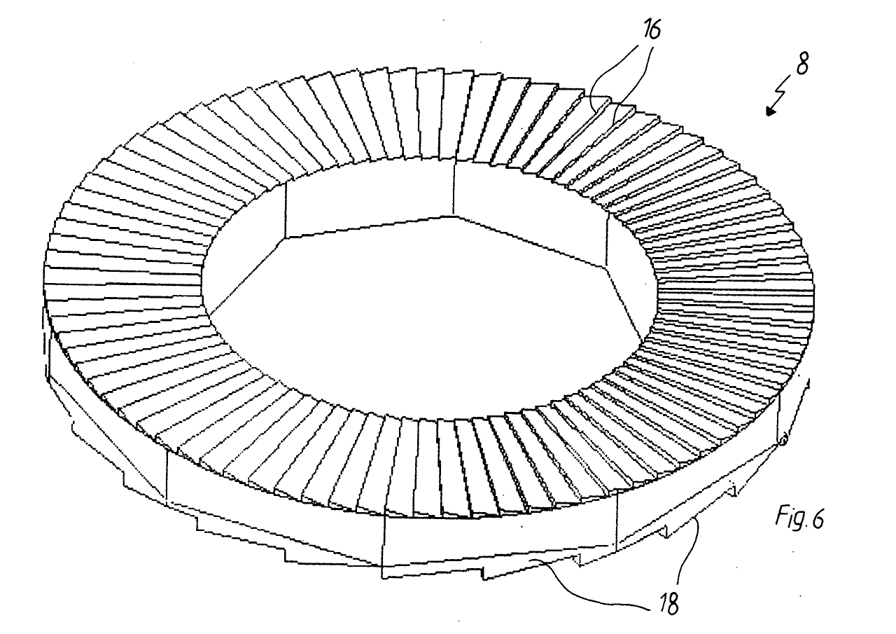

FIG. 6 is a perspective view of a washer-like locking element.

FIG. 1 shows a piston rod 1 which extends as a spigot 2 at the end, in the region of which a damping piston 3, shown only schematically here, is positioned. The damping piston 3 is firmly connected to the piston rod 1 by means of a nut 4 which is screwed onto the threaded spigot 2. The damping piston 3 includes a plurality of valve arrangements for the extension and compression stages of a vibration damper. In order to avoid unintentional loosening of the nut 4 during operation a screw locking arrangement 5 is used which is shown on a larger scale in the right-hand image of FIG. 1. The nut 4 and the spigot 2 are shown. The figure does not show that the spigot 2 is provided with a thread at least in the region of the nut 4. On the upper housing part 6 of the damping piston 3, which is not shown in more detail in the enlarged image, a plurality of plain washers 7, 7′, 7″ which are of different thicknesses are positioned. These plain washers serve in a known manner to resiliently support the valve washers, and by means of these plain washers the damping characteristics in the extension and compression stages of vibration damper are adjusted. The different thicknesses are merely intended to accommodate different applications, e.g. to adjust valve characteristics on shock absorbers, or a different geometrical design with respect to the construction height of the damping piston 3.

Of substantial significance is the assurance that the nut 4 will not be loosened during operation of the vibration damper, e.g. induced by the high-frequency mechanical vibrations, and that the necessary pretensioning force of the connection is provided throughout the service life of the damper. The plain washers 7, 7′, 7″ are not fixed in this example but much rather lie loosely on the facing surface 6 of the valve washer covering the orifices in the damping piston 3. In this example the screw locking arrangement 5 in accordance with the invention is produced by a locking system comprising first and second locking washers 8, 9. The end surface 10 of the first locking washer 8 facing the nut 4 is provided with a rotational locking profile (e.g. radial ribs) which is pressed into the nut 4 when the connection is being tightened and therefore positively locks the washer 8 to the nut 4. The same applies for the end surface 11 of the second locking washer 9 of the locking system facing the thicker plain washer 7″.

In this example the screw locking arrangement 5 in accordance with the invention is now achieved by producing a positive rotational locking arrangement between the second locking washer 9 of the locking system and the spigot 2. In this example a single lug-like radial projection 12 is thereby integrally formed on the second locking washer 9 and is guided in a longitudinal groove 13 in the spigot 2. Therefore relative rotation of the second locking washer 9 of the locking system with respect to the spigot 2 in the peripheral direction is no longer possible. Furthermore, in the region of the mutually facing end surfaces 14, 15 of the locking washers 8, 9 profiling, which cannot be seen in more detail here, is provided. Reference is made to the detailed views of FIGS. 4 to 6 in this respect.

When the plain washers 7, 7′ are free to move in the peripheral direction, the nut 4 and the plain washer 7′ are therefore decoupled by reason of the positive connection between the locking system, formed by the locking washers 8, 9, and the spigot 2. The screw connection can therefore no longer come loose by itself and the necessary pretensioning force of the screw connection is retained over the service life of the damper.

FIG. 2 shows a cross-sectional view along the line B-B of FIG. 1. The second locking washer 9 of the locking system is shown by hatching, together with the lug-like radial projection 12.

FIG. 3 shows as a schematic diagram the first locking washer 8 of the locking system together with an indication of the ribs 16 (rotational locking profile) on the end surface 10 facing the nut 4 when in the installed condition.

FIG. 4 shows a cross-sectional view through the locking washers 8, 9, wherein the locking washer 9 is provided with a wedge-like profile 17. The locking washer 8 also has a wedge-like profile 18 in the region of its end surface 15, which profile engages into the profile 17 of the locking washer 9. By means of the pitch of the profiles 17, 18, forming wedge-like toothing, which is greater than the thread pitch of the spigot 2, a self-limiting arrangement for the locking system is achieved. As also shown in FIG. 3, the end surfaces 10, 11 of the locking washers 8, 9 are provided with radial ribs 16 as a rotational locking profile. It should be pointed out that in the case of the exemplified embodiment of the invention illustrated in the drawings the rotational locking profile 16 shown in FIG. 4 on the second locking washer 9 can be omitted because the second locking washer 9 is secured against rotation by the radial projection 12 which engages into the groove 13 of the spigot 2. The washers 7, 7′, 7″ can rotate without a loosening moment being transferred to the nut 4.

FIG. 5 shows as a schematic diagram a partial view of the second locking washer 9. It is possible to see the profile 17, provided with the corresponding pitch, and the radial projection 12 which is formed in a lug-like manner. As shown in FIG. 4 the wedge-shaped profile 18 engages into the profile 17 of the locking washer 9 so that the already mentioned self-limitation of the connection is achieved. As a result of the positive rotational locking arrangement between the locking washer 9 and the spigot 2 by means of the radial projection 12 which is guided in the longitudinal groove 13 of the spigot 2, transfer to the nut 4 of a turning moment which would loosen the nut 4 is no longer possible when the nut 4 is tightened.

Although not illustrated herein, it is also alternatively possible for example for the plain washer 7″ directly adjoining the second locking washer 9 to be provided with a lug-like radial projection engaging into the longitudinal groove 13, wherein then a corresponding rotational locking profile must be provided between the plain washer 7″ and the locking washer 9, which profile positively locks the two washers 7″, 9 (e.g. by means of radial ribs) when the screw connection is being tightened.

Although not illustrated herein, it is also feasible for the plain washer 7″ to replace the second locking washer 9 of the locking system and therefore to become the same part of the locking system. By these means the second locking washer 9 illustrated in the exemplified embodiment of the drawing is omitted and the construction height of the whole system can advantageously be reduced.

FIG. 6 shows by way of example the first locking washer 8 of the locking system, which is not provided with a radial projection (see FIG. 5). It is possible to see the profile 18 formed as toothing, and the rib-like rotational locking profile 16.

### REFERENCE LIST

1 piston rod
2 spigot
3 damping piston
4 nut
5 screw locking arrangement
6 upper housing part
7 plain washer
7′ plain washer
7″ plain washer
8 first locking washer
9 second locking washer
10 upper end surface
11 lower end surface
12 radial projection
13 longitudinal groove
14 end surface
15 end surface
16 rotational locking profile (ribs)
17 wedge-like profile (toothing)
18 wedge-like profile (toothing)

1. Screw locking arrangement for a screw connection comprising a threaded spigot, a nut, a first locking washer and at least one second locking washer, wherein the first locking washer is connected in a non-rotational manner to the nut, wherein the first locking washer has first profiling on a first surface and the second locking washer has second profiling on a second surface, and wherein the profiling of the first locking washer is engaged with that of the second locking washer in such a way that relative rotation of the two locking washers with respect to each other can be effected in only one rotational direction which leads to an increase in the tensioning force of the screw connection, characterized in that between the second locking washer and the threaded spigot a positive rotational locking arrangement is provided.

2. Screw locking arrangement as claimed in claim 1, characterized in that the first locking washer (8) forms one piece with the groove.

3. Screw locking arrangement as claimed in claim 1, characterized in that the first locking washer is formed as a component separate from the nut, and that a non-rotational positive connection is provided between the nut and the first locking washer.

4. Screw locking arrangement as claimed in claim 3, characterized in that the positive connection is produced by a rotational locking profile formed on the surface of the first locking washer facing the nut, which profile engages into a corresponding profile on the surface of the nut facing the locking washer.

5. Screw locking arrangement as claimed in claim 1, characterized in that two locking washers are provided and the positive rotational locking arrangement is formed by at least one radial projection which is formed on the second locking washer and which engages in a longitudinal groove formed in the threaded spigot, and that a plain washer disposed adjacent to the second locking washer is provided to support further plain washers.

6. Screw locking arrangement as claimed in claim 1, characterized in that two locking washers are provided, and the positive rotational locking arrangement is formed by at least one radial projection which is formed on the second locking washer and which engages into a longitudinal groove formed in the threaded spigot, and that the second locking washer is formed in such a way that it fulfills a supporting function for further plain washers.

7. Screw locking arrangement as claimed in claim 1, characterized in that two locking washers and a plain washer are provided, wherein the plain washer has at least one radial projection which, in order to form the positive rotational locking arrangement, engages into a longitudinal groove formed in the threaded spigot, wherein between the second locking washer and the plain washer a rotational locking arrangement is provided.

8. Screw locking arrangement as claimed in claim 5 above, characterized in that the threaded spigot is the piston rod spigot formed at the end of a piston rod of a shock absorber.
